(19) United States
(12) Patent Application Publication
(10) Pub. No.: US 2026/0005741 A1
(43) Pub. Date: Jan. 1, 2026

(54) WIRELESS COMMUNICATION DEVICE AND WIRELESS COMMUNICATION SYSTEM

(71) Applicant: Fujikura Ltd., Tokyo (JP)

(72) Inventors: Ryohei Sugiura, Sakura-shi (JP); Yuki Suto, Sakura-shi (JP)

(73) Assignee: Fujikura Ltd., Tokyo (JP)

(21) Appl. No.: 19/241,886

(22) Filed: Jun. 18, 2025

(30) Foreign Application Priority Data
Jun. 27, 2024 (JP) 2024-103890

(51) Int. Cl. H04B 7/06; H01Q 3/34; H04B 7/0426; H04W 4/44

(52) U.S. Cl. CPC H04B 7/0617; H01Q 3/34; H04B 7/043; H04W 4/44

(57) ABSTRACT

A wireless communication system includes a wireless communication device and a plurality of wireless devices. The wireless communication device includes a phased array antenna having a beam forming function, and a control unit that controls a direction of a beam of the phased array antenna and performs control of providing a service according to the direction of the beam of the phased array antenna. For example, the wireless communication device is installed on a platform, the wireless device is installed on a train that enters the platform, and the wireless communication device provides a service of causing a monitor provided on the train that enters a track of the platform to display an image of the track of the platform where the train enters.

### CROSS-REFERENCE TO RELATED APPLICATION

Priority is claimed on Japanese Patent Application No. 2024-103890, filed Jun. 27, 2024, the content of which is incorporated herein by reference.

### BACKGROUND OF THE INVENTION

### Field of the Invention

The present invention relates to a wireless communication device and a wireless communication system.

### Description of Related Art

In the related art, a technology of supporting the driving of a vehicle formation by presenting an image of a platform to a driver of the vehicle formation has been known. This technology uses a wireless communication system that transmits an image captured by a camera installed at platform to a vehicle formation, receives the transmitted image, and outputs the image to a liquid crystal display device installed at a driver's seat of the vehicle formation to cause the liquid crystal display device to display the image. For details of such a wireless communication system, for example, refer to Japanese Unexamined Patent Application, First Publication No. 2023-40544 and Japanese Unexamined Patent Application, First Publication No. 2009-255782.

### SUMMARY OF THE INVENTION

Meanwhile, the relationship between a track and a vehicle formation to be entered is often forced to change due to disruption of the schedule or maintenance. Therefore, in the above-described wireless communication system, it is preferable that identification settings (for example, a center frequency and a service set identifier (SSID) during wireless communication) for communication are common settings for all vehicle formations. Therefore, in the wireless communication system in the related art, there is a problem that a detection system for detecting a vehicle formation that enters a track of a platform is separately required to provide an appropriate image to a vehicle formation that enters the track of the platform, and introduction costs are high.

The present invention has been made in view of the above circumstances, and an object of the present invention is to provide a wireless communication device and a wireless communication system that can provide an appropriate service according to a communication partner while suppressing introduction costs.

A wireless communication device according to a first aspect of the present invention includes a phased array antenna having a beam forming function, and a control unit that is configured to control a direction of a beam of the phased array antenna and perform control of providing a service according to the direction of the beam of the phased array antenna.

The wireless communication device according to the first aspect of the present invention includes the phased array antenna having the beam forming function, and the control unit. Also, the control unit performs the control of controlling the direction of the beam of the phased array antenna according to the position of a wireless device that is a communication partner, and providing a service according to the direction of the beam of the phased array antenna. Accordingly, it is possible to provide an appropriate service according to the communication partner while suppressing introduction costs.

In addition, a wireless communication device according to a second aspect of the present invention is the wireless communication device according to the first aspect of the present invention, further including a beam table in which first information indicating the direction of the beam of the phased array antenna and second information related to the service to be provided are associated with each other, in which the control unit may control the direction of the beam of the phased array antenna by using the beam table, and may perform control of providing a service according to the controlled beam direction based on the second information associated with the first information indicating the controlled beam direction.

In addition, a wireless communication device according to a third aspect of the present invention is the wireless communication device according to the second aspect of the present invention further including a plurality of ports in which at least one of input or output of data corresponding to the service to be provided is performed, in which the second information is identification information for identifying the ports, and the control unit may control data input and output through the ports identified by the identification information associated with the first information indicating the controlled beam direction such that the data is transmitted and received in the controlled beam direction.

In addition, a wireless communication device according to a fourth aspect of the present invention is the wireless communication device according to any one of the first to third aspects of the present invention, in which the direction of the beam of the phased array antenna may be a direction in which a main lobe of a radiation pattern of the phased array antenna appears.

In addition, a wireless communication device according to a fifth aspect of the present invention is the wireless communication device according to any one of the first to fourth aspects of the present invention, in which the control unit may control the direction of the beam of the phased array antenna such that reception power of a partner device that performs wireless communication is maximized.

A wireless communication system according to a sixth aspect of the present invention includes the wireless communication device according to any one of the first to fifth aspects of the present invention, and a plurality of wireless devices that perform wireless communication with the wireless communication device.

In addition, a wireless communication system according to a seventh aspect of the present invention is the wireless communication system according to the sixth aspect of the present invention, in which the wireless communication device is installed in a platform, and the wireless device may be installed in a vehicle formation that enters the platform.

In addition, a wireless communication system according to an eighth aspect of the present invention is the wireless communication system according to the seventh aspect of the present invention, in which the control unit of the wireless communication device may control the direction of the beam of the phased array antenna to allow wireless communication with the wireless device installed in the vehicle formation that enters a different track of the platform.

In addition, a wireless communication system according to a ninth aspect of the present invention is the wireless communication system according to the seventh or eighth aspect of the present invention, in which the wireless communication device may provide, to the vehicle formation that enters the platform, a service of transmitting an image of the platform corresponding to a track of the platform where the vehicle formation enters, and the wireless device receives the image transmitted from the wireless communication device, and may output the image to a display device installed in the vehicle formation to cause the display device to display the image.

According to the present invention, there is an effect that it is possible to provide an appropriate service according to a communication partner while suppressing introduction costs.

### BRIEF DESCRIPTION OF THE DRAWINGS

FIG. 1 is a block diagram showing a wireless communication system according to a first embodiment of the present invention.

FIG. 2 is a diagram showing an example of a beam table used in the first embodiment of the present invention.

FIG. 3 is a diagram showing an example of a beam formed in the wireless communication system according to the first embodiment of the present invention.

FIG. 4 is a block diagram showing a wireless communication system according to a second embodiment of the present invention.

FIG. 5 is a timing chart showing the operation of the wireless communication system according to the second embodiment of the present invention.

FIG. 6 is a block diagram showing a wireless communication system according to a third embodiment of the present invention.

### DETAILED DESCRIPTION OF THE INVENTION

Hereinafter, a wireless communication device and a wireless communication system according to embodiments of the present invention will be described in detail with reference to the drawings.

### First Embodiment

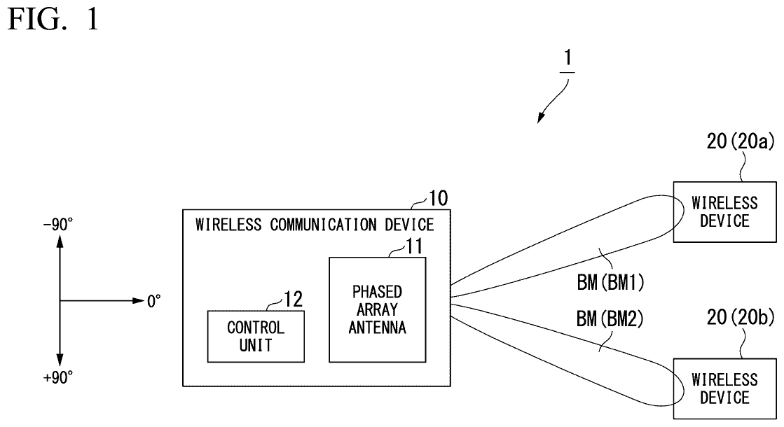

FIG. 1 is a block diagram showing a wireless communication system according to a first embodiment of the present invention. As shown in FIG. 1, a wireless communication system 1 of the present embodiment includes a wireless communication device 10 and a plurality of wireless devices (peer device) 20, and is a system capable of performing point-to-multipoint communication between the wireless communication device 10 and the plurality of wireless devices 20. In the wireless communication system 1, the wireless communication device 10 and the plurality of wireless devices 20 perform wireless communication, so that it is possible to provide services according to the wireless devices 20.

The wireless communication system 1 performs wireless communication using, for example, a high-frequency signal such as a microwave, a quasi-millimeter wave, or a millimeter wave. In addition, the wireless communication system 1 performs wireless communication compliant with, for example, a wireless communication standard IEEE 802.11ad. The wireless communication device 10 corresponds to a base station device that manages the connection, and corresponds to, for example, an access point (AP) and a PBSS control point (PCP) defined by the wireless communication standard IEEE 802.11. The plurality of wireless devices 20 correspond to wireless terminals connected to the base station device, and correspond to, for example, a station (STA) defined by the wireless communication standard IEEE 802.11. In FIG. 1, two wireless devices 20a and 20b are shown as the plurality of wireless devices 20, but the number of wireless devices 20 is not limited to two. The number of wireless devices 20 may be three or more.

The wireless communication device 10 includes a phased array antenna 11 and a control unit 12, and provides a service according to the direction of a beam BM of the phased array antenna 11. The provision of audio, images, characters, figures, and various other types of data suitable for the wireless devices 20 is an exemplary example of the services provided by the wireless communication device 10. The services provided by the wireless communication device 10 are not limited to the provision of the above-described various types of data and may be any services.

The phased array antenna 11 includes a plurality of antenna elements (not shown), and is an antenna capable of freely changing a beam pattern (antenna directivity). That is, the phased array antenna 11 is an antenna having a beam forming function. In the phased array antenna 11, a beam forming function is realized by adjusting at least one of the intensity or the phase, or both of the intensity and the phase of a signal (transmission signal) supplied to a plurality of antenna elements or a signal (reception signal) supplied from a plurality of antenna elements.

In the phased array antenna 11, any beam pattern can be formed by adjusting the above intensity and phase. In the present embodiment, in order to facilitate understanding, it is assumed that two beams BM shown in FIG. 1 are formed as the beam pattern of the phased array antenna 11. The direction of the formed beam BM is a direction in which a main lobe of the radiation pattern of the phased array antenna 11 appears. One beam BM1 of the two beams BM is directed to the wireless device 20a, and the other beam BM2 is directed to the wireless device 20b.

In the present embodiment, as shown in FIG. 1, the angle of the beam BM radiated from the wireless communication device 10 in the right direction of the drawing is set to 0°. Then, from this angle (0°), a rightward (clockwise) angle is positive and a leftward (counterclockwise) angle is negative. Therefore, the beam BM1 that is directed to the wireless device 20a is represented by a negative angle, and the beam BM2 that is directed to the wireless device 20b is represented by a positive angle.

The control unit 12 controls the direction of the beam of the phased array antenna 11 and performs the control of providing a service according to the direction of the beam of the phased array antenna 11. Here, the control unit 12 controls the direction of the beam BM of the phased array antenna 11 such that the reception power of the wireless device 20 that performs wireless communication is maximized. In the example shown in FIG. 1, the direction of the beam BM1 is controlled such that the reception power of the wireless device 20a is maximized, and the direction of the beam BM2 is controlled such that the reception power of the wireless device 20b is maximized.

The control unit 12 performs the control of providing a service according to the direction of the beam BM of the phased array antenna 11 after controlling the direction of the beam BM of the phased array antenna 11. Specifically, the control unit 12 performs control by using a beam table BT in which information (first information) indicating the direction of the beam BM of the phased array antenna 11 and information (second information) related to services to be provided are associated with each other.

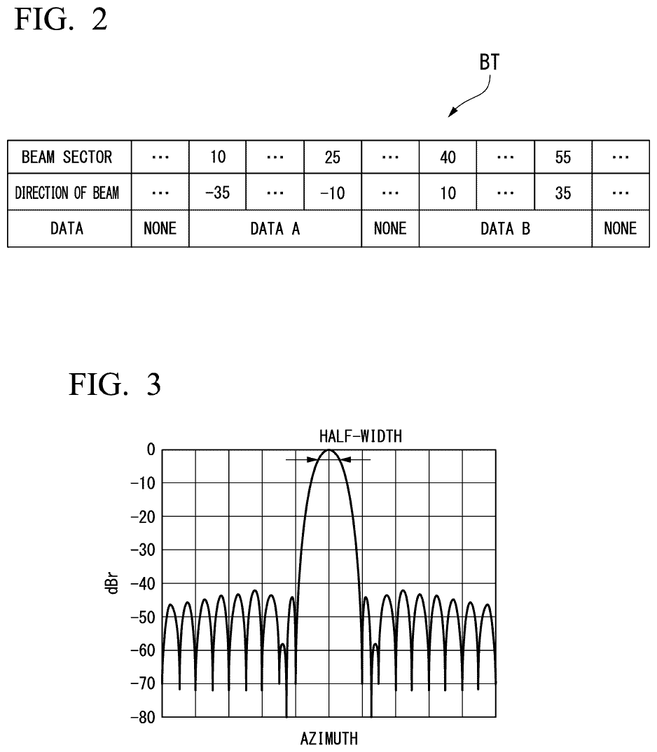

FIG. 2 is a diagram showing an example of a beam table used in the first embodiment of the present invention. As shown in FIG. 2, the beam table BT is a table in which a beam sector (first information), a direction of a beam (first information), and data (second information) are associated with each other.

The beam sector is information for specifying a beam formed by the phased array antenna 11, and, for example, an integer (number) in a range of 0 to 63 is stored. The direction of the beam is information indicating the direction of the beam BM of the phased array antenna 11, and, for example, any angle in a range of −90° to +90° is stored. Since the beam sector and the direction of the beam are associated with each other on a one-to-one basis, the direction of the beam is specified in a case where the beam sector is specified.

The data is information indicating data used corresponding to services to be provided, and for example, data A indicating that the data is used in a service A, data B indicating that the data is used in a service B, and the like are stored. In a case where no service is provided, “None” is stored.

In the example shown in FIG. 2, in a case where the beam sector is 10, −35° is stored as the direction of the beam, and in a case where the beam sector is 25, −10° is stored as the direction of the beam. In a case where the beam sector is 40, 10° is stored as the direction of the beam, and in a case where the beam sector is 55, 35° is stored as the direction of the beam. In the example shown in FIG. 2, in a case where the beam sector is other than 10, 25, 40, and 55, the correspondence relationship between the beam sector and the direction of the beam is not shown.

In addition, in the example shown in FIG. 2, in a case where the beam sector is 10 to 25 (in a case where the direction of the beam is −35° to −10°), the data A is stored as the data. In a case where the beam sectors is 40 to 55 (in a case where the direction of the beam is 10° to 35°), the data B is stored as the data. In the example shown in FIG. 2, in a case where the beam sector is 0 to 9, 26 to 39, and 56 to 63, “None” is stored in the data.

The control unit 12 controls the direction of the beam BM of the phased array antenna 11 by using the beam table BT shown in FIG. 2. After controlling the direction of the beam BM of the phased array antenna 11, the control unit 12 performs the control of providing a service according to the controlled direction of the beam BM based on data associated with a beam sector that specifies the direction of the beam BM.

For example, it is assumed that the wireless device 20a is disposed at a position defined at an angle of −10° with respect to the wireless communication device 10, and the wireless device 20b is disposed at a position defined at an angle of 10° with respect to the wireless communication device 10. In a case where the control unit 12 controls the direction of the beam BM of the phased array antenna 11 to a direction specified by the beam sector of 25, the control unit 12 performs the control of providing the data A to the wireless device 20a located in the direction. In addition, in a case where the control unit 12 controls the direction of the beam BM of the phased array antenna 11 to a direction specified by the beam sector of 40, the control unit 12 performs the control of providing the data B to the wireless device 20b located in the direction.

The wireless device 20 is a device that performs wireless communication with the wireless communication device 10. The wireless device 20 may be any device capable of wireless communication with the wireless communication device 10. The wireless device 20 includes an antenna and a control unit that controls wireless communication performed with the wireless communication device 10. The antenna provided in the wireless device 20 may be any antenna such as a directional antenna or an omnidirectional antenna. In addition, the wireless device 20 may include a phased array antenna, as in the wireless communication device 10.

The wireless device 20 may be fixedly disposed or may be movably disposed. In a case where the wireless device 20 is fixedly disposed, the direction of the beam BM formed by the phased array antenna 11 of the wireless communication device 10 does not change. On the other hand, in a case where the wireless device 20 is movably disposed, the direction of the beam BM formed by the phased array antenna 11 of the wireless communication device 10 changes according to the position of the wireless device 20.

Here, it is preferable that the wireless device 20 is separated from the wireless communication device 10 by a distance that is equal to or greater than twice a half-width of the beam BM formed by the phased array antenna 11 provided in the wireless communication device 10 in an angular direction with respect to the wireless communication device 10. For example, it is desirable that an angle formed by a straight line passing through the wireless communication device 10 and the wireless device 20a and a straight line passing through the wireless communication device 10 and the wireless device 20b is equal to or greater than twice the half-width of the beam BM. This is to suppress unintended data communication.

FIG. 3 is a diagram showing an example of a beam formed in the wireless communication system according to the first embodiment of the present invention. As described above, the direction of the beam BM formed by the phased array antenna 11 is a direction in which the main lobe of the radiation pattern of the phased array antenna 11 appears. The half-width of the beam BM is an angle of the beam BM in a portion where the intensity of the beam BM decreases by 3 dB from the maximum value of the main lobe.

In addition, in a case where the wireless device 20 is movably disposed, it is preferable that the movable range of the beam BM formed by the phased array antenna 11 of the wireless communication device 10 is set to be minimized according to a movable range of the wireless device 20. This is to prevent erroneous detection of an optimal transmission beam sector caused by the multipath due to unintended reflection.

In the example shown in FIG. 2, the movable range of the beam BM is limited to a range in which the beam sector is 10 to 25 (the direction of the beam is −35° to −10°) and a range in which the beam sector is 40 to 55 (the direction of the beam is 10° to 35°). The movable range of the beam BM may be restricted by the beam sector or may be restricted by another method. For example, the movable range of the beam BM may be restricted by adjusting a phase amount set in a phase shifter (not shown) provided corresponding to each of the plurality of antenna elements provided in the phased array antenna 11 such that the beam BM is formed only in a specific direction.

In the above configuration, in a case where the power of the wireless communication device 10 is turned on, the control unit 12 first controls the phased array antenna 11 with reference to the beam table BT shown in FIG. 2 to sequentially change the direction of the beam BM. Then, the control unit 12 controls the direction of the beam BM of the phased array antenna 11 such that the reception power of the wireless device 20 that performs wireless communication is maximized. In the example shown in FIG. 2, the direction of the beam BM1 is controlled such that the reception power of the wireless device 20a is maximized, and the direction of the beam BM2 is controlled such that the reception power of the wireless device 20b is maximized. For example, the control unit 12 controls the direction of the beam BM1 to a direction) (−10°) specified by the beam sector of 25, and controls the direction of the beam BM2 to a direction) (10°) specified by the beam sector of 40.

Next, the control unit 12 performs the control of providing a service according to the controlled direction of the beam BM with reference to the beam table BT shown in

FIG. 2. For example, the control unit 12 provides the data A corresponding to the direction) (−10°) in which the beam sector is specified as 25 to the wireless device 20a located in the direction with reference to the beam table BT. In addition, the control unit 12 provides the data B corresponding to the direction) (10°) in which the beam sector is specified as 40 to the wireless device 20b located in the direction with reference to the beam table BT. In this way, the service according to the direction of the beam of the phased array antenna 11 is provided.

As described above, in the present embodiment, the wireless communication device 10 includes the phased array antenna 11 having the beam forming function and the control unit 12. Then, the control unit 12 controls the direction of the beam BM of the phased array antenna 11 according to the position of the wireless device 20 that is a communication partner, and performs the control of providing a service according to the direction of the beam BM of the phased array antenna 11. Accordingly, it is possible to provide an appropriate service according to the communication partner while suppressing introduction costs.

### Second Embodiment

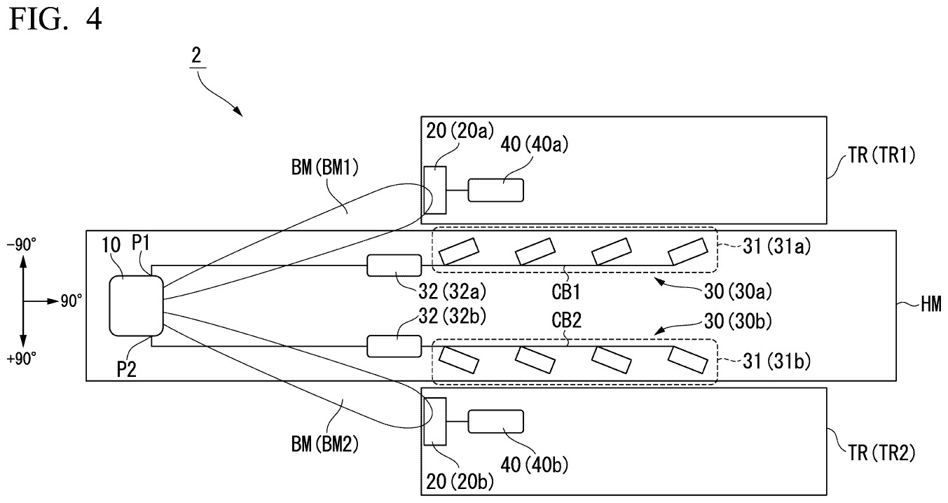

FIG. 4 is a block diagram showing a wireless communication system according to a second embodiment of the present invention. A basic configuration of the wireless communication system 2 of the present embodiment is the same as that of the wireless communication system 1 of the first embodiment. Therefore, in FIG. 4, the same reference numerals are assigned to the same components as the components shown in FIG. 1. The wireless communication system 2 of the present embodiment is applied to a monitoring system that monitors a platform HM of a station or the like.

As shown in FIG. 4, the wireless communication system 2 of the present embodiment includes a plurality of image transmission systems 30 and a plurality of monitors 40 (display devices) in addition to the wireless communication device 10 and the plurality of wireless devices 20. The wireless communication device 10 and the plurality of image transmission systems 30 are installed on a platform HM of a station, and the plurality of wireless devices 20 and the monitor 40 are installed on each of a plurality of trains TR (vehicle formations).

The image transmission system 30 includes a camera group 31 and an image synthesis device 32, and synthesizes an image captured by the camera group 31 with the image synthesis device 32 to transmit the image to the wireless communication device 10. In the example shown in FIG. 4, an image transmission system 30a that captures an image of one track of the platform HM (hereinafter, referred to as a “first track”) and an image transmission system 30b that captures an image of the other track of the platform HM (hereinafter, referred to as a “second track”) are provided. In FIG. 4, the two image transmission systems 30a and 30b are shown as the plurality of image transmission systems 30, but the number of image transmission systems 30 is not limited to two. The number of image transmission systems 30 may be three or more.

The image transmission system 30a includes a camera group 31a and an image synthesis device 32a. The camera group 31a includes a plurality of cameras connected by a cable CB1. The plurality of cameras provided in the camera group 31a are disposed along the platform HM (in an entrance direction of the train TR) on the first track side of the platform HM. That is, the plurality of cameras included in the camera group 31a are arranged to capture images at different positions on the first track side of the platform HM. The image synthesis device 32a synthesizes (encodes) images captured by the plurality of cameras included in the camera group 31a and transmitted through the cable CB1. The image synthesis device 32a is connected to a port P1 of the wireless communication device 10 and outputs a synthesized image to the wireless communication device 10.

The image transmission system 30b includes a camera group 31b and an image synthesis device 32b. The camera group 31b includes a plurality of cameras connected by a cable CB2. The plurality of cameras included in the camera group 31b are disposed along the platform HM (in the entrance direction of the train TR) on the second track side of the platform HM. That is, the plurality of cameras included in the camera group 31b are arranged to capture images at different positions on the second track side of the platform HM. The image synthesis device 32b synthesizes (encodes) the images captured by the plurality of cameras provided in the camera group 31b and transmitted through the cable CB2. The image synthesis device 32b is connected to a port P2 of the wireless communication device 10 and outputs a synthesized image to the wireless communication device 10.

The wireless communication device 10 controls the beam BM1 formed by the phased array antenna 11 to be directed to the wireless device 20a provided in a train TR1 that enters the first track (or the train TR1 that departs from the first track). Then, the wireless communication device 10 provides a service of transmitting the image input to the port P1 toward the wireless device 20a located in the direction of the beam BM1.

As described above, in the present embodiment, the port P1 of the wireless communication device 10 is associated with the beam BM1 transmitted toward the wireless device 20a. That is, in the present embodiment, information indicating that the data A is the data to be input from the port P1 is stored in the beam table BT shown in FIG. 2. For example, identification information for identifying the port P1 is stored as the data A of the beam table BT shown in FIG. 2.

In addition, the wireless communication device 10 controls the beam BM2 formed by the phased array antenna 11 to be directed to the wireless device 20b provided in a train TR2 that enters the second track (or the train TR2 that departs from the second track). Then, the wireless communication device 10 provides a service of transmitting the image input to the port P2 toward the wireless device 20b located in the direction of the beam BM2.

As described above, in the present embodiment, the port P2 of the wireless communication device 10 is associated with the beam BM2 transmitted toward the wireless device 20b. That is, in the present embodiment, information indicating that the data B is the data to be input from the port P2 is stored in the beam table BT shown in FIG. 2. For example, identification information for identifying the port P2 is stored as the data B of the beam table BT shown in FIG. 2.

The monitor 40 includes, for example, a display device such as a liquid crystal display device, and decodes and displays an image received by the wireless device 20 and output from the wireless device 20. The monitor 40 is installed, for example, in a driver's seat of the train TR. In the example shown in FIG. 4, a monitor 40a is installed in the train TR1 that enters the first track of the platform HM, and a monitor 40b is installed in the train TR2 that enters the second track of the platform HM. In FIG. 4, the two monitors 40a and 40b are shown as the plurality of monitors 40, but the number of monitors 40 is not limited to two. The monitors 40 may be provided in, for example, all the trains TR that are scheduled to enter the platform HM.

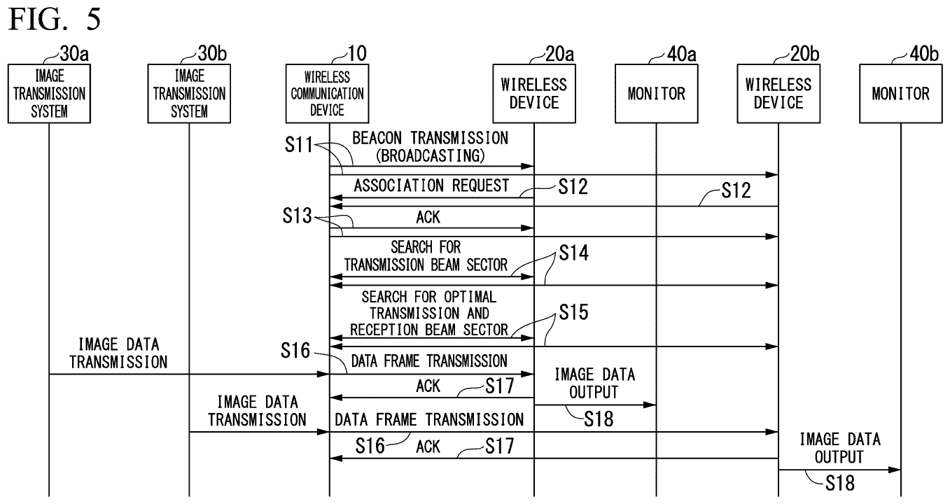

FIG. 5 is a timing chart showing the operation of the wireless communication system according to the second embodiment of the present invention. Here, for simplification of the explanation, an operation in a case where, at the same time, the train TR1 enters the first track of the platform HM and the train TR2 enters the second track of the platform HM is described as an example.

The wireless communication device 10 transmits a beacon by broadcasting at a regular time interval (step S11). In a case where the train TR1 enters the first track of the platform HM and the train TR2 enters the second track of the platform HM, the beacon transmitted from the wireless communication device 10 is received by the wireless device 20a provided in the train TR1 and the wireless device 20b provided in the train TR2. In a case where the beacon is received, the wireless device 20a and the wireless device 20b check the SSID and the like, and then transmit an association request to the wireless communication device 10 (step S12).

In a case where the association request transmitted from the wireless device 20a and the wireless device 20b is received, the wireless communication device 10 transmits an acknowledgement (ACK) to each of the wireless device 20a and the wireless device 20b (step S13). Accordingly, an association is established between the wireless communication device 10 and the wireless devices 20a and 20b.

In a case where the association is established, a search for a transmission beam sector is performed between the wireless communication device 10 and the wireless devices 20a and 20b (step S14). For example, in a case where the phased array antennas are also provided in the wireless devices 20a and 20b, the wireless communication device 10, the wireless device 20a, and the wireless device 20b are brought into a quasi-omni (quasi-omnidirectional) state to search for the transmission beam sector during reception.

In a case where the search for the transmission beam sector ends, the search for an optimal transmission and reception beam sector is performed between the wireless communication device 10 and the wireless devices 20a and 20b (step S15). Specifically, a reception side is put into a beam forming mode, and processing is performed to search for an optimal beam sector (beam direction) in transmission and reception.

The optimal beam sector is a beam sector in which the reception power is maximized on the wireless devices 20a and 20b side, and is a state in which transmission and reception beam directions (directions in which the main lobe appears) of the wireless communication device 10 and the wireless devices 20a and 20b face each other. In a case where the optimal transmission and reception beam sector is searched for, for example, as shown in FIG. 4, the beam BM1 is directed to the wireless device 20a provided in the train TR1, and the beam BM2 is directed to the wireless device 20b provided in the train TR2.

The position of the wireless device 20a changes according to the movement of the train TR1, and the position of the wireless device 20b changes according to the movement of the train TR2. Therefore, the search for the optimal transmission and reception beam sector is continued at least until the trains TR1 and TR2 stop.

In a case where the optimal transmission and reception beam sector is searched for, the wireless communication device 10 refers to the beam table BT and transmits data corresponding to the searched optimal beam sector to the wireless devices 20a and 20b in the form of a data frame (step S16). Specifically, the wireless communication device 10 transmits the image (image output from the image transmission system 30a) input to the port P1 identified by the identification information corresponding to the beam sector of the beam BM1 toward the wireless device 20a located in the direction of the beam BM1. In addition, the wireless communication device 10 transmits the image (image output from the image transmission system 30b) input to the port P2 identified by the identification information corresponding to the beam sector of the beam BM2 toward the wireless device 20b located in the direction of the beam BM2.

In a case where the data frame transmitted from the wireless communication device 10 is received, the wireless devices 20a and 20b transmit an ACK (step S17). Then, each of the wireless devices 20a and 20b output the received image data to each of the monitors 40a and 40b (Step S18). Accordingly, an image captured by the camera group 31a of the image transmission system 30a is displayed on the monitor 40a provided in the train TR1, and an image captured by the camera group 31b of the image transmission system 30b is displayed on the monitor 40b provided in the train TR2.

As described above, in the present embodiment, the wireless communication device 10 is installed in the platform HM, and each of the wireless devices 20a and 20b that perform wireless communication with the wireless communication device 10 is installed in each of the trains TR1 and TR2. Then, the wireless communication device 10 controls the direction of the beam BM1 according to the position of the wireless device 20a, transmits the image (image of the first track of the platform HM where the train TR1 enters) captured by the image transmission system 30a to the wireless device 20a, and displays the image on the monitor 40a. In addition, the wireless communication device 10 controls the direction of the beam BM2 according to the position of the wireless device 20b, and transmits the image (image of the second track of the platform HM where the train TR2 enters) captured by the image transmission system 30b to the wireless device 20b to display the image on the monitor 40b.

As described above, in the present embodiment, the monitor 40 provided in the train TR that enters the track of the platform HM can be caused to display the image of the track of the platform HM where the train TR enters, without separately providing a detection system that detects a train that enters the track of the platform HM. That is, even in the present embodiment, it is possible to provide an appropriate service according to a communication partner while suppressing the introduction costs.

In the present embodiment, it is desirable that, at the position where the association request shown in FIG. 5 is transmitted, an angle formed by a straight line passing through the wireless communication device 10 and the wireless device 20a and a straight line passing through the wireless communication device 10 and the wireless device 20b is equal to or greater than twice the half-width of the beam BM. This is to suppress unintended data communication. In addition, it is preferable that the movable range of the beams BM1 and BM2 formed by the phased array antenna 11 of the wireless communication device 10 is set to be minimum according to the movable range of the wireless device 20 installed in the train TR. This is to prevent erroneous detection of an optimal transmission beam sector caused by the multipath due to unintended reflection.

In addition, as means for detecting the position at which the above-mentioned association request is transmitted, speed information from the train TR during stop operation (during speed reduction), distance information to the stop position, a global positioning system (GPS) signal, and the like are used. The wireless communication device 10 and the wireless device 20 start the association request with the detection of the above position as a trigger by using these signals.

### Third Embodiment

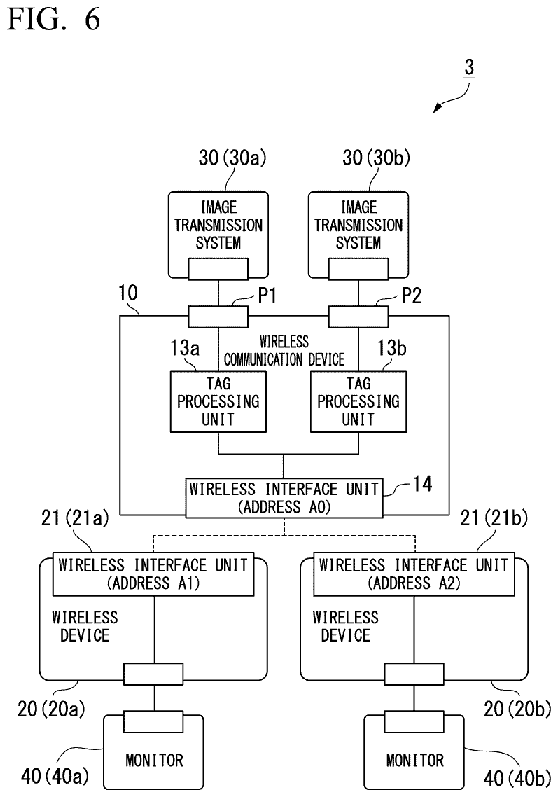

FIG. 6 is a block diagram showing a wireless communication system according to a third embodiment of the present invention. A wireless communication system 3 of the present embodiment is basically the same as the wireless communication system 2 of the second embodiment. Therefore, in FIG. 6, the same reference numerals are assigned to the same components as the components shown in FIG. 4. In the wireless communication system 3 of the present embodiment, point-to-multipoint communication performed between the wireless communication device 10 and the wireless devices 20a and 20b is realized through a virtual local area network (VLAN) by using, for example, an L2 bridge.

As shown in FIG. 6, each of the image transmission systems 30a and 30b is connected to each of the ports P1 and P2 of the wireless communication device 10, for example, by Ethernet (registered trademark). In addition, each of the monitors 40a and 40b is connected to each of the wireless devices 20a and 20b by, for example, Ethernet (registered trademark).

The wireless communication device 10 includes tag processing units 13a and 13b and a wireless interface unit 14. The tag processing unit 13a is provided between the port P1 and the wireless interface unit 14 to perform tag processing on data (frame) exchanged between the port P1 and the wireless interface unit 14. The tag processing unit 13b is provided between the port P2 and the wireless interface unit 14 to perform tag processing on data (frame) exchanged between the port P2 and the wireless interface unit 14.

Specifically, the tag processing unit 13a performs the processing of inserting a VLAN tag (identifier) into a frame sent from the port P1 to the wireless interface unit 14. The tag processing unit 13a also performs the processing of removing a VLAN tag inserted into a frame sent from the wireless interface unit 14 to the port P1. The tag processing unit 13b performs the processing of inserting a VLAN tag into a frame sent from the port P2 to the wireless interface unit 14. The tag processing unit 13b also performs the processing of removing a VLAN tag inserted into a frame sent from the wireless interface unit 14 to the port P2.

A VLAN tag (hereinafter, referred to as a “first VLAN tag”) to be processed by the tag processing unit 13a and a VLAN tag (hereinafter, referred to as a “second VLAN tag”) to be processed by the tag processing unit 13b are different from each other. For example, the first VLAN tag is an identifier having a value of “1”, and the second VLAN tag is an identifier having a value of “2”. In the present embodiment, in the beam table BT shown in FIG. 2, the first VLAN tag is stored as the data A, and the second VLAN tag is stored as the data B.

As described above, in the present embodiment, the beam sector and the VLAN tag are associated with each other in the beam table BT. In addition, in a case where the wireless communication device 10 and the wireless devices 20a and 20b perform association, the address of each communication partner is acquired. The address of the communication partner is a media access control (MAC) address. Therefore, in the present embodiment, the beam sector, the MAC address, and the VLAN tag are associated with each other.

Specifically, the beam sector of the beam BM1 (see FIG. 4), the MAC address of the wireless interface unit 21a, and the first VLAN tag are associated with each other. In addition, the beam sector of the beam BM2 (see FIG. 4), the MAC address of the wireless interface unit 21b, and the second VLAN tag are associated with each other. In FIG. 6, the MAC address of the wireless interface unit 14 is indicated by A0, the MAC address of the wireless interface unit 21a is indicated by A1, and the MAC address of the wireless interface unit 21b is indicated by A2.

The wireless interface unit 14 performs the transmission control of the frames output from the tag processing units 13a and 13b with reference to the correspondence relationship between the beam table BT and the MAC address. Specifically, the wireless interface unit 14 refers to a beam sector to be transmitted to the wireless interface unit 21a specified by the MAC address. In a case where the referenced beam sector is a value in a range of 10 to 25 shown in FIG. 2, the transmission control is performed such that a frame in which the first VLAN tag is inserted is transmitted to the wireless interface unit 21a specified by the MAC address. In a case where the referenced beam sector is a value in a range of 40 to 55 shown in FIG. 2, the transmission control is performed such that a frame in which the second VLAN tag is inserted is transmitted to the wireless interface unit 21a specified by the MAC address.

In addition, the wireless interface unit 14 refers to a beam sector to be transmitted to the wireless interface unit 22b specified by the MAC address. Then, in a case where the referenced beam sector is a value in a range of 10 to 25 shown in FIG. 2, the transmission control is performed such that a frame into which the first VLAN tag is inserted is transmitted to the wireless interface unit 21b specified by the MAC address. In a case where the referenced beam sector is a value in a range of 40 to 55 shown in FIG. 2, the transmission control is performed such that a frame into which the second VLAN tag is inserted is transmitted to the wireless interface unit 21b specified by the MAC address. In the wireless communication device 10, as in the second embodiment, the directions of the beams BM1 and BM2 are also separately controlled with reference to the beam table BT.

In this way, as in the second embodiment, the image captured by the image transmission system 30a is transmitted to the wireless device 20a and displayed on the monitor 40a. In addition, the image captured by the image transmission system 30b is transmitted to the wireless device 20b and displayed on the monitor 40b.

As described above, in the present embodiment, as in the second embodiment, the wireless communication device 10 is installed in the platform HM, and each of the wireless devices 20a and 20b that perform wireless communication with the wireless communication device 10 is installed in each of the trains TR1 and TR2. Then, the wireless communication device 10 controls the direction of the beam BM1 according to the position of the wireless device 20a, transmits the image (image of the first track of the platform HM where the train TR1 enters) captured by the image transmission system 30a to the wireless device 20a, and displays the image on the monitor 40a. In addition, the wireless communication device 10 controls the direction of the beam BM2 according to the position of the wireless device 20b, and transmits the image (image of the second track of the platform HM where the train TR2 enters) captured by the image transmission system 30b to the wireless device 20b to display the image on the monitor 40b.

As described above, even in the present embodiment, the monitor 40 provided in the train TR that enters the track of the platform HM can be caused to display the image of the track of the platform HM where the train TR enters, without separately providing a detection system that detects a train that enters the track of the platform HM. That is, even in the present embodiment, it is possible to provide an appropriate service according to a communication partner while suppressing the introduction costs.

Although the wireless communication device and the wireless communication system according to the embodiments of the present invention have been described above, the present invention is not limited to the above-described embodiments and can be freely modified within the scope of the present invention. Additions, omissions, substitutions, and other modifications can be made without departing from the scope of the invention. Accordingly, the invention is not to be considered as being limited by the foregoing description and is only limited by the scope of the appended claims.

For example, the services provided in the above second and third embodiments are services of causing the monitor 40 provided in the train TR that enters the track of the platform HM to display images of tracks of the platform HM where the train TR enters. However, on the contrary, a service of causing a monitor provided for each track of the platform HM is made to display an image of the train TR (for example, an image in the train TR) that enters the track of the platform HM may be provided.

What is claimed is:

1. A wireless communication device comprising:
a phased array antenna having a beam forming function; and
a control unit that is configured to control a direction of a beam of the phased array antenna and perform control of providing a service according to the direction of the beam of the phased array antenna.

2. The wireless communication device according to claim 1, further comprising:
a beam table in which first information indicating the direction of the beam of the phased array antenna and second information related to the service to be provided are associated with each other,
wherein the control unit controls the direction of the beam of the phased array antenna by using the beam table, and performs control of providing a service according to the controlled beam direction based on the second information associated with the first information indicating the controlled beam direction.

3. The wireless communication device according to claim 2, further comprising:
a plurality of ports in which at least one of input or output of data corresponding to the service to be provided is performed,
wherein the second information is identification information for identifying the ports, and
the control unit controls data input and output through the ports identified by the identification information associated with the first information indicating the controlled beam direction such that the data is transmitted and received in the controlled beam direction.

4. The wireless communication device according to claim 1,
wherein the direction of the beam of the phased array antenna is a direction in which a main lobe of a radiation pattern of the phased array antenna appears.

5. The wireless communication device according to claim 1,
wherein the control unit controls the direction of the beam of the phased array antenna such that reception power of a peer device that performs wireless communication is maximized.

6. A wireless communication system comprising:
the wireless communication device according to claim 1; and
a plurality of wireless devices that perform wireless communication with the wireless communication device.

7. The wireless communication system according to claim 6,
wherein the wireless communication device is installed in a platform, and
the wireless device is installed in a vehicle formation that enters the platform.

8. The wireless communication system according to claim 7,
wherein the control unit of the wireless communication device controls the direction of the beam of the phased array antenna to allow wireless communication with the wireless device installed in the vehicle formation that enters a different track of the platform.

9. The wireless communication system according to claim 7,
wherein the wireless communication device provides, to the vehicle formation that enters the platform, a service of transmitting an image of the platform corresponding to a track of the platform where the vehicle formation enters, and
the wireless device receives the image transmitted from the wireless communication device, and outputs the image to a display device installed in the vehicle formation to cause the display device to display the image.
